(19) United States
(12) Patent Application Publication
(10) Pub. No.: US 2021/0129804 A1
(43) Pub. Date: May 6, 2021

(54) TRAILER MANEUVERING APPARATUS

(71) Applicant: Trailer Drive LLC, Helena, MT (US)

(72) Inventors: Annie Novotny, Shepherd, MT (US); John Novotny, Helena, MT (US)

(73) Assignee: Trailer Drive LLC, Helena, MT (US)

(21) Appl. No.: 17/018,724

(22) Filed: Sep. 11, 2020

Related U.S. Application Data
(60) Provisional application No. 62/898,604, filed on Sep. 11, 2019.

(51) Int. Cl. B60S 13/00

(52) U.S. Cl. CPC B60S 13/00

(57) ABSTRACT

A remote-controlled lifting and maneuvering device and a process of remotely controlling a trailer maneuvering device by use of a remote control is provided. The remote-controlled lifting and maneuvering device allows a single operator to both raise and lower the tongue of a trailer, and maneuver a trailer without having to apply physical force to the trailer or maneuver a towing vehicle. The lifting mechanism may be achieved using a hydraulic jack component, an electrical jack or other actuating component. The movement and maneuverability of the device may be achieved using a maneuvering system. This combination of a jack component and maneuvering system may be adapted for maneuvering a trailer into position, raising the trailer to an appropriate height, and finally lowering the trailer for affixing to a towing vehicle.

### CROSS REFERENCE TO RELATED APPLICATION

This application claims the benefit of co-pending provisional application Ser. No. 62/898,604, filed on Sep. 11, 2019, entitled TRAILER MOVING TECHNIQUE.

### FIELD

The present invention is generally directed to device and method for improving the efficiency and effectiveness of remotely maneuvering and attaching a trailer to a towing vehicle.

### BACKGROUND

There are a number of mechanisms for fixing and attaching trailers to a towing vehicle, and several designs have been in use for over forty years. While possible, manually affixing a trailer to a towing vehicle is arduous, time consuming, and can even pose physical risk to the operator. To alleviate the problems in efficiency and health, lifting mechanisms have developed over time to make this process easier. The sophistication of these mechanisms vary from hand-operated wheel cranks, foot-operated cranks, and even button operated hydraulic and electric jacks. Both hydraulic jacks and electric jacks eliminate the need for physical force to be applied by the operator, saving time and reducing the risk of physical harm to the operator.

While providing a benefit, hydraulic jacks do not solve all problems when affixing a trailer to a towing vehicle. The original designs of hydraulic jacks were limited to stationary devices that were only capable of raising and lowering the tongue of a trailer, but were incapable of maneuvering the trailer once the tongue was raised. This limitation causes problems in affixing the trailer to a towing vehicle. With these limited devices, the operator must line up the tongue of the trailer with the towing device perfectly, and then maneuver the towing device to the appropriate positioning to then lower the tongue of the trailer. This method requires flawless execution from the operator, or else requires considerable time and energy to correct the positioning of the trailer or vehicle. This design flaw required considerable back and forth by a solo operator, or required the assistance of an additional person.

To address this limitation, there are currently hydraulic and electric jacks that incorporate a wheel at the bottom of the jack for maneuvering the trailer that has been raised. An example of one such mobile electric jack is the Northern Tool+Equipment Ultra-Tow 12 Volt Swivel Electric Trailer Jack. This device incorporates a wheel at the bottom of the electric jack, allowing the operator to maneuver the trailer once raised. Once the tongue of the trailer is raised, the operator is able to move the trailer forwards, backwards, and side-to-side, without having to lower the tongue of the trailer back to the ground. By improving on the mobility and maneuverability of the trailer, the operator is not forced to reposition the towing vehicle itself.

But, the currently designed mobile jacks are not without limitations. In order to maneuver the raised tongue of the trailer, the operator must apply physical force to actually move and maneuver the trailer. The wheeled designs are non-motorized and require considerable force to be applied by the user to actually maneuver and move the trailer into position. These problems are only enhanced in poor weather conditions, uneven or muddy ground, or with operators that suffer from physical limitations. Additionally, of the available mobile jacks, the wheeled components are not made from a durable material, and can be prone to wear and tear, requiring replacement.

Accordingly, a need exists for a jack that provides the benefits of automatically raising and lowering the tongue of a trailer but also improving on the maneuverability of navigating a trailer and affixing to a towing vehicle. A need also exists for a jack and maneuvering system that provides long-term consistent performance in unforgiving environments. A further need exists for a jack that can be used by operators with physical limitations.

### SUMMARY

The present invention addresses the limitations of the prior art by providing an apparatus, which includes a remote-controlled lifting and maneuvering device and a process of remotely controlling a trailer maneuvering device by use of a remote control. The present invention allows a single operator to both raise and lower the tongue of a trailer, and maneuver a trailer without having to apply physical force to the trailer or maneuver a towing vehicle. The lifting mechanism may be achieved using a hydraulic jack component, an electrical jack or other actuating component. The movement and maneuverability of the device may be achieved using a maneuvering system including a roller chain system, and a wheel located at the bottom of the hydraulic jack component. This combination of a jack component and maneuvering system may be adapted for maneuvering a trailer into position, raising the tongue of the trailer to an appropriate height, and finally lowering the tongue of the trailer for affixing to a towing vehicle.

### BRIEF DESCRIPTION OF THE DRAWINGS

In the accompanying drawings, which form a part of the specification and are to be read in conjunction therewith in which like reference numerals are used to indicate like or similar parts in the various views:

FIG. 1 is a top side view of a lifting and maneuvering device in accordance with one embodiment of the present invention;

FIG. 2 is a side schematic view of a maneuvering device of a lifting and maneuvering device in accordance with one embodiment of the present invention;

FIG. 3 is a front schematic view of a maneuvering device of a lifting and maneuvering device in accordance with one embodiment of the present invention;

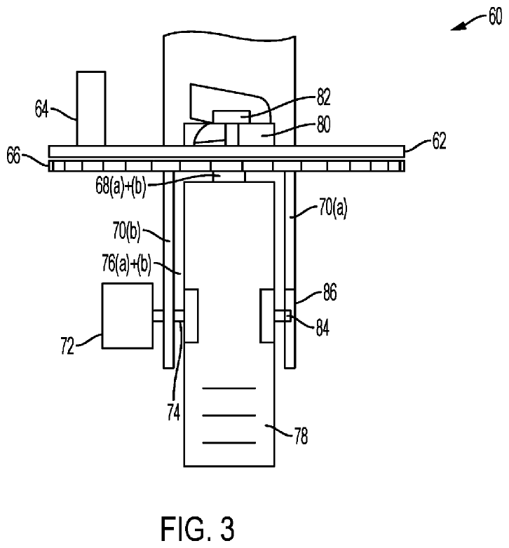

FIG. 4 is a perspective view of the maneuvering device of FIG. 1 secured to a trailer;

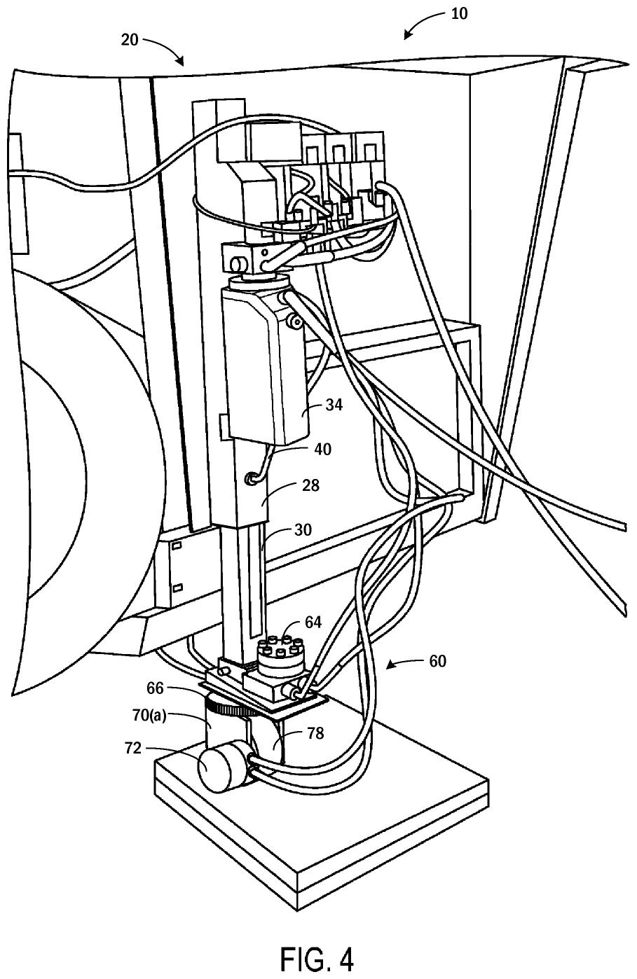

FIG. 5 is a perspective view of the maneuvering device of FIG. 4 rotated 180 degrees; and

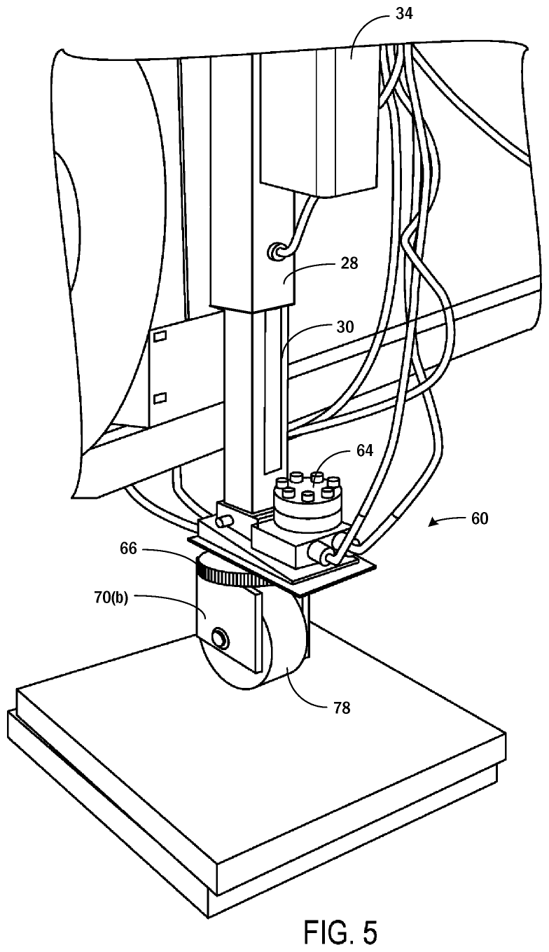

FIG. 6 is a perspective view of the maneuvering device of FIG. 4 rotated 90 degrees.

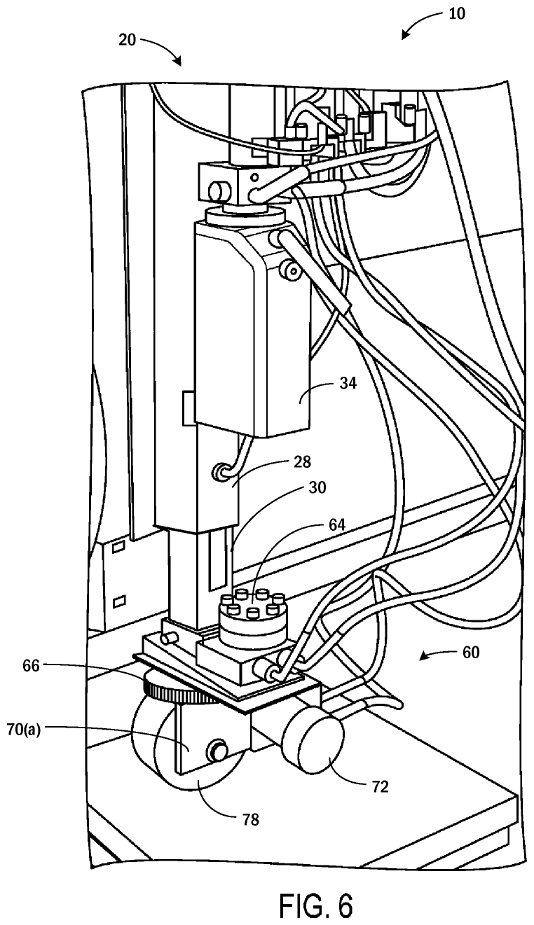

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures. It will be appreciated that any dimensions included in the drawing figures are simply provided as examples and dimensions other than those provided therein are also within the scope of the invention.

The following detailed description of the invention references specific embodiments in which the invention can be practiced. The embodiments are intended to describe aspects of the invention in sufficient detail to enable those skilled in the art to practice the invention. Other embodiments may be utilized, and changes may be made without departing from the scope of the present invention. The present invention is defined by the claims and the description is, therefore, not to be taken in a limiting sense and shall not limit the scope of equivalents to which such claims are entitled.

The present invention is directed generally to a remote-controlled lifting and maneuvering device 10 for lifting the tongue of a trailer and maneuvering the trailer, and to a process of remotely controlling a trailer maneuvering device by use of a remote control. The present invention allows the operator to both raise and lower the tongue of a trailer, and maneuver a trailer without having to apply physical force to the trailer or maneuver a towing vehicle. In one embodiment of the device 10 of the present invention, the lifting mechanism may be achieved using a hydraulic jack component 20, but it will be appreciated by a person skilled in the art that an electrical jack, pneumatic jack, or other actuating component could also be used. In one embodiment, the movement and maneuverability of the device 10 may be achieved using a maneuvering system 60 including a roller chain system 66, 72 and a grooved metal wheel 78 located at the bottom of the hydraulic jack component 20. This combination of a hydraulic jack component 20 and maneuvering system 60 may be adapted for maneuvering a trailer into position, raising the tongue of the trailer to an appropriate height, and finally lowering the tongue of the trailer for affixing to a towing vehicle.

Referring to the figures, one embodiment of the lifting and maneuvering device 10 of the present invention that may be designed to raise and lower the tongue or front end of a trailer and is generally illustrated. As shown, the lifting and maneuvering device 10 may be comprised of a combination of a hydraulic jack component 20 and a maneuvering system 60 connected to the bottom of the hydraulic jack component 20. This embodiment of the device 10 may be affixed to a horse trailer, flatbed trailer, or any other type of trailer or similar apparatus. When affixed it will be appreciated that the device 10 may be operated to raise and lower the tongue of the trailer it is affixed to. It will be appreciated that once the tongue of the trailer is raised, the trailer may be positioned so that it may then be affixed to a towing vehicle such as a truck, tractor, or all-terrain vehicle. In the current embodiment of the present invention, the device 10 may be affixed to the tongue of a trailer at an affixing point 22 using an affixing point fastener 24. The affixing point fastener may be achieved using a bolt, clamp, or similar fastener.

It will be further appreciated from the embodiment as shown in the figures that the lifting and maneuvering device 10 may also comprise a wheel 78 located at the bottom end of the hydraulic jack component 20. In the embodiment as demonstrated in the figures, the wheel 78 may be attached in a swivel manner such that the wheel 78 can be turned 360 degrees. When attached to a trailer through the hydraulic jack component 20, the maneuvering system 60 may be used to move the attached trailer in a horizontal plane forwards, backwards, and any other direction. It will be appreciated that the trailer may be maneuvered in any position and height, depending on the length of the device 10 of the present invention.

According to one embodiment as shown in the figures, the hydraulic jack component 20 may be comprised of a hydraulic fluid container 34, hydraulic fluid piping, hoses or similar fluid transporting apparatus 36, 38, 40, 42, and 44, a control panel 32, a container sleeve 26, and extension members 28 and 30. The hydraulic jack component 20 may function as prior known hydraulic jacks operate. In the current embodiment of the present invention, the hydraulic jack component 20 may be powered by an external power source such as an a/c current, gasoline, diesel, or other external power sources. It will be appreciated that the hydraulic jack component 20 may be powered through an internal power source as well. The hydraulic jack component 20 may be made out of steel, iron, aluminum, or other materials.

According to one embodiment, when powered, hydraulic fluid flows from the hydraulic fluid reservoir 34 to the internal pumping chamber (not shown) to the actuator containment tube (not shown) and back to the hydraulic reservoir chamber 34. Leaking from the hydraulic reservoir chamber 34 may be prevented through use of a hydraulic fluid reservoir plug 34(a). Once powered, the hydraulic fluid from the hydraulic fluid reservoir 34 may leave the hydraulic fluid reservoir 34 passing through an extend solenoid (not shown). Once passing through the extend solenoid (not shown), the hydraulic fluid may enter into a hydraulic fluid extent piping 36 through the extent piping port 38 and enter the circuiting body (not shown) of the hydraulic jack component 20.

The circuiting body (not shown) may be rigidly fixed to an elongated tube (not shown) which itself may be rigidly fixed to a bracket (not shown). The width of the bracket (not shown) may extend beyond the diameter of the tube (not shown) and the length of the bracket (not shown) extends along the length of the tube (not shown).

When the hydraulic jack component 20 is in the vertical, weight-bearing position, the path of weight transfer may proceed from a flange (not shown) through the bracket (not shown) through the elongated tube (not shown), and to the hydraulic circuiting body (not shown) which can be mechanically affixed to an actuator containment tube (not shown) further comprising an actuator seal (not shown). These parts may be mechanically connected to form the first parts group of the hydraulic jack components 20 weight-bearing path.

The second parts group of the hydraulic jack components 20 weight-bearing path, collectively referred to as the extension member or extension piece, may also be rigidly assembled by mechanical means. This second group may include an upper extension member 28 and a lower extension member 30 whose function is to transfer the weight to the ultimate weight-bearing agent. The lower extension member 30 may be received inside of the upper extension member 28.

The load-bearing functions of each group may be coupled together by means of hydraulic fluid whose load-bearing integrity may be maintained by an upper seal (not shown) and lower seal (not shown), upper fluid checked ball (not shown) and lower fluid check ball (not shown), and the hydraulic circuiting body (not shown). Additionally, the hydraulic fluid reservoir 34 and actuator containment tube (not shown) may be shut off from one another so that hydraulic fluid may be pumped from the hydraulic fluid reservoir 34 through a first passageway to the pumping cavity (not shown), and then through a first passageway to the pumping cavity (not shown), and then through a second passageway (not shown) into the actuator containment tube (not shown) by means of handle pivoting about block to alternatively lift and lower pump actuator (not shown) in the pumping cavity (not shown). The pumping action of this block and lever pump (not shown) causes the hydraulic fluid to flow from the hydraulic fluid reservoir 34 through the pumping cavity chamber (not shown) and to the hydraulic jack actuator containment tube (not shown). This flow may be maintained by the ball valve arrangement comprised of hydraulic fluid check balls (not shown) or other similarly effective maintaining methods.

As the pump actuator (not shown) is lifted, the lower fluid check ball (not shown) may be engaged in seat while simultaneously the upper fluid check ball (not shown) is relieved from the seat. The pumping cavity (not shown) is thus filled with hydraulic fluid drawn from the hydraulic fluid reservoir 34 until the actuator (not shown) ceases the lifting motion. The block (not shown) can be designed to stop the lifting motion at a designated point.

As the actuator (not shown) is lowered, the upper fluid check ball (not shown) may be engaged in the seat and simultaneously the lower fluid ball (not shown) may be relieved from seat thus permitting flow of the hydraulic fluid from the pumping cavity (not shown) to the jack actuator containment tube (not shown). The introduction of hydraulic fluid into actuator containment tube (not shown) displaces the jack actuator (not shown) into an extended position. As the pumping action continues, the hydraulic jack component 20 lifts the tongue of the trailer, or other structure, until the hydraulic jack actuator (not shown) reaches the position of maximum displacement. This maximum displacement may be designed into the hydraulic jack component 20. It will be appreciated by those skilled in the art that other valve means can also be used with the present invention.

The hydraulic jack actuator (not shown) and the remainder of the second parts group may be retracted from the extended position by an opening valve so that hydraulic fluid can flow from the now pressurized jack actuator containment tube (not shown) to the hydraulic fluid storage reservoir 34. As the hydraulic fluid leaves the circuiting body (not shown), the hydraulic fluid enters a retract port 42, through a retract piping 40, or similar hosing, tube, or piping. As the hydraulic fluid flows through the retract piping 40, the fluid springs, each attached between a lug on the lower shaft and a lug on the elongated tube (not shown), provide additional retractive force to retract the second parts group.

It is also recognized that in alternative embodiments of the present invention, the lifting and maneuvering device 10 of the present invention may incorporate any other suitable type of hydraulic jack component, electric jack component or other actuating device component configured to raise and lower the device 10.

The hydraulic jack component 20 may be affixed to a horse trailer or other similar apparatus by means of a fastener 24 or other affixing method, including, but not limited to a bolt, clamp, or pin. In one embodiment of the present invention, the hydraulic jack component 20 may be affixed to the tongue of a trailer by aligning an affixing point 22 located near the top of the hydraulic jack, to an affixing point on the tongue of the trailer, located near the front of the trailer tongue, near the hitch. Then, a bolt or similar fastening device 24 may be inserted into the affixing points 22, and held in place with a coupler pin, clamp, or other fastener 24.

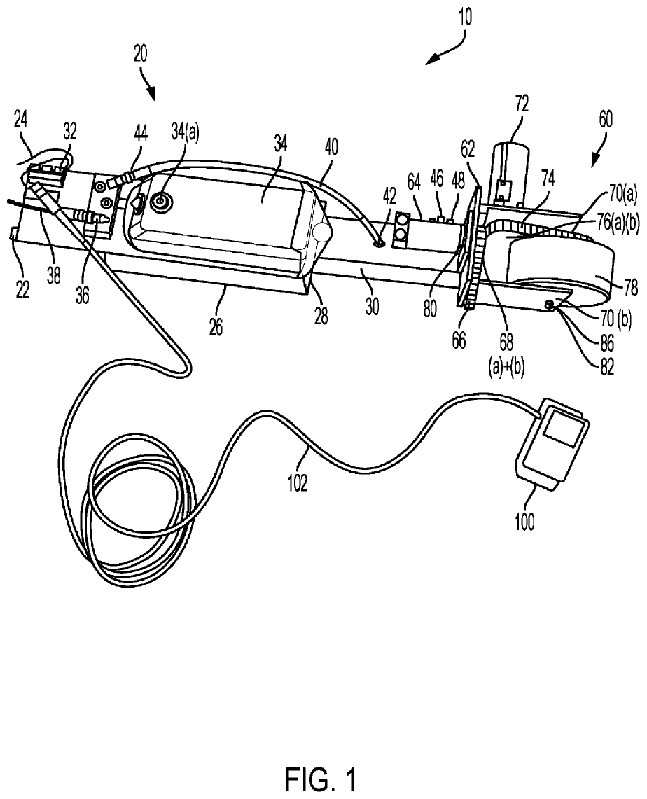

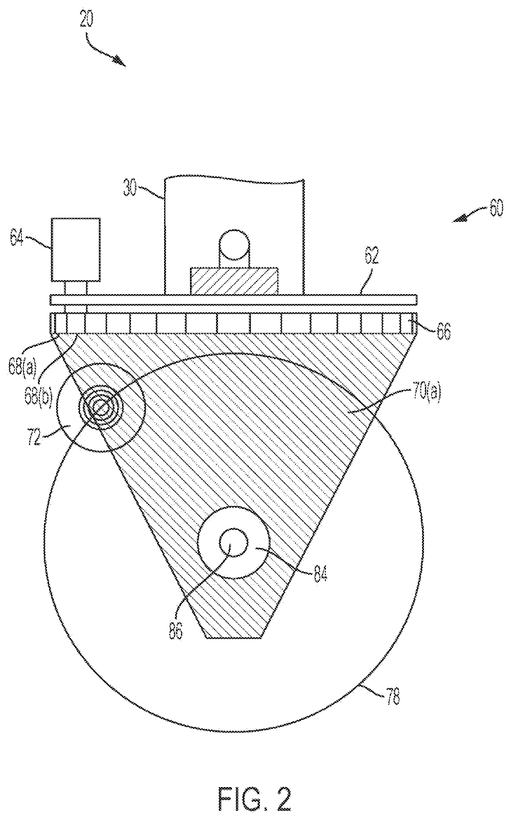

The lifting and maneuvering device 10 of the present invention may further comprise a maneuvering system 60. In one embodiment of the present invention, the maneuvering system 60 may comprise a wheel 78 or similar mobility apparatus for maneuvering a trailer or similar structure. As best illustrated in FIGS. 1 and 2, below the lower extension member 30 there may be a top plate 62 of ¼, ⅙, ⅛ inch thickness or similar size that may be attached through welding or similar fastening methods to the bottom of the lower extension member 30. The design of the top plate 62 may vary, and may be square, round, or any other shape. Additionally, the material of the top plate 62 may vary and may be made out of steel, aluminum, or other materials. At a point on the top plate 62 there may be at least one motor for powering a mechanized wheel 78 or similar maneuverability device. The maneuvering motor 64 may have at least one port for connecting the motor to a power source. The maneuvering motor 64 may be configured to accept multiple sources of power, including but not limited to an a/c current, gasoline, diesel, and other methods of powering a motor. The maneuvering motor 64 may also be configured to operate on an interior power source.

In one embodiment of the present invention, the maneuvering motor 64 may be connected to, and power, a maneuvering roller chain 66 to control the direction of the maneuvering system 60 and therefore the lifting and maneuvering device 10. The maneuvering roller chain 66 may be operated by one or more bore sprockets 76 with a connection to the maneuvering motor 64, there will also be at least one other sprocket 76 located on the top plate 62. The bore sprockets 76 may be connected to the top plate 62 and combined with the maneuvering roller chain 66. It will be appreciated that when powered by the maneuvering motor 64, that the bore sprockets 76 will cause the maneuvering roller chain 66 to transmit rotary motion of the maneuvering roller chain 66, thus allowing the direction of the hydraulic jack component 20 to change. In one embodiment of the device 10 of the present invention, the maneuverability roller chain 66 controlled by the maneuvering motor 64 will allow the hydraulic jack component 20 to rotate in a 360 degree manner in a horizontal plane.

Below the top plate 62 there is a wheel 78. The wheel 78 may be affixed to the top plate 62 through a ball and socket bearing 80 or other fastening means. It will be appreciated that the wheel 78 may be replaced with a tread system or other method of moving device. The wheel 78 may be made out of steel, aluminum, or other material. According to one embodiment of the present invention, the wheel 78 may also comprise grooves or treads for improved efficiency in mud or other wet conditions. On opposite ends of the wheel 78, two plates 70 may be connected to the wheel 78 by means of a pin bearing, screw, bolt, or other method of fastening. The plates 78 may be made out of steel, iron, aluminum, or other materials. The fastening method may be performed in a manner so that the wheel 78 will still have a full range to rotate completely.

In the present embodiment there may be at least one movement motor 72 connected to at least one of the plates 78. This movement motor 72 may be used to control the motion of the wheel 78 and may be used to rotate the wheel 78 to move the trailer forward or backwards. The movement motor 72 may be connected to an external power source such as a battery, A/C current, gasoline engine, or other power source, or it may utilize an internal power source. According to one embodiment of the present invention, the movement motor 72 may be connected to, and power, a movement roller chain 74 connected to the wheel 78. The movement roller chain 74 may be powered with bore sprockets 76 connected to the movement motor 72. It will be appreciated that when powered by the movement motor 72, that the bore sprockets 76 may cause the movement roller chain 74 to transmit rotary motion of the wheel 78. Thus, it will be appreciated that when combined, the movement motor 72 may cause the wheel 78 to rotate forwards or backwards which will in turn cause the attached trailer to move forwards or backwards.

It will be appreciated that when combined, the maneuvering motor 64 and the movement motor 72 may be able to simultaneously control the two sets of roller chains, the maneuvering roller chain 66 to control the direction the device 10 will face, and the movement roller chain 74 controlling the movement of the wheel 78. According to embodiment of the present invention, the maneuvering motor 64 located on the top plate 62 may be able to control the maneuvering roller chain 66 to rotate the device 10 in a 360 degree manner. The movement motor 72 located on a side plate 70 may be able power the wheel 78 forwards and backwards, allowing the wheel 78 and connected hydraulic jack component 20 forwards and backwards. When the hydraulic jack component 20 and maneuverability systems 60 are combined, the maneuvering system 60 may be able to move forward, backward, side-to-side, and in any direction in a 360 degree direction while the hydraulic jack component 20 may be able to raise and lower the attached trailer.

The lifting and maneuvering device 10 may be controlled from one central control system, connected through the control panel 32. The control system may control both the hydraulic jack component 20, lifting and lowering the connected trailer and may also be used to control the maneuverability system 60 to move the trailer forwards, backwards, side-to-side, and any other maneuverability direction. According to one embodiment of the present invention, the control system may be operated by a remote control 100. The remote control 100 may be physically connected to the control panel 32 through a physical cord 102 or it may be remotely connected through Bluetooth or other wireless system. The remote control 100 may have buttons, levers, joysticks, or other combinations of control components. It will be appreciated by those skilled in the art that when the button, lever, or control component of the remote control 100 is activated, the corresponding effect will occur on the trailer lifting and maneuvering device.

From the foregoing, it will be seen that the present invention 10 provides several new and useful improvements over existing jack systems. By providing a motorized maneuvering system 60 to the bottom of the hydraulic jack component 20, a single user may effectively raise the tongue of a trailer, remotely maneuver that trailer into position, and finally lower the tongue of the trailer onto the hitch of a towing vehicle. The present invention 10 allows the operator to raise the tongue of the trailer using the hydraulic jack component 20, and then with the maneuverability system 60, remotely move the trailer up to the towing vehicle, remotely adjust the height of tongue of the trailer accordingly, and finally lower the tongue of the trailer onto the hitching post of the towing vehicle. The only physical force needed to operate the current invention 10 is in the attaching and removing of the invention 10 from the trailer. The motorized wheel 78 of the maneuvering system 60 provides aid to the operator and removes the need for physically pushing and pulling against the trailer to attempt to maneuver it into position. This feature is enhanced by the maneuverability function of the maneuvering system 60 using the maneuverability roller chain 66. This maneuverability roller chain 66 allows for immediate and precise modification of the direction of the trailer allowing the operator to line up the trajectory of the trailer to the towing vehicle hitch. Because of the maneuvering motor 64 powering the maneuvering system 60, this accurate lining up and moving of the trailer can be done remotely. Once the trailer is affixed to the towing vehicle, the present invention 10 may be easily removed from the tongue of the trailer for storage or for immediate use on another trailer. The features of the present invention allow for an accurate method of affixing a trailer to a towing vehicle. A task that once took multiple people and significant time and labor, may now be achieved with a solo operator without using physical force in lifting, maneuvering, and hitching a trailer.

From the foregoing, it will be appreciated that this invention is one well adapted to attain all the ends and objects hereinabove set forth together with other advantages which are inherent to the structure and method. It will be understood that certain features and subcombinations are of utility and may be employed without reference to other features and subcombinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

Having thus described the invention, what is claimed as new and desired to be secured by Letters Patent is as follows:

1. A system for maneuvering and hitching a trailer, the system comprising:
a lifting jack component configured to raise and lower a tongue of a trailer in a vertical direction;
a maneuvering device component connected to said lifting jack component and configured to maneuver a trailer in a horizontal direction; and
an affixing member to connect said lifting jack component to the tongue of the trailer.

2. The system of claim 1 wherein said lifting jack component is configured as a hydraulic jack.

3. The system of claim 1 wherein said maneuvering device component includes a wheel.

4. The system of claim 3 wherein said maneuvering device component is configured to move said wheel in the front, back, left and right directions.

5. The system of claim 4 wherein said maneuvering device component is configured to rotate said wheel 360 degrees.

6. The system of claim 1 further comprising a remote control to control said lifting jack component and said maneuvering device component.

7. The system of claim 1 said maneuvering device component includes a first motor coupled to said wheel to turn said wheel in a horizontal plane, and a second motor coupled to said wheel to rotate said wheel.

8. An apparatus for maneuvering a trailer, the apparatus comprising:
a lifting jack configured to raise and lower a tongue of a trailer in a vertical direction;
a maneuvering device coupled to said lifting jack and configured to maneuver a trailer in a horizontal direction;
a bracket mounted to said lifting jack opposite said maneuvering device; and
a fastener to connect said bracket to the tongue of the trailer.

9. The system of claim 8 wherein said lifting jack is configured as a hydraulic jack.

10. The system of claim 8 wherein said maneuvering device includes a wheel.

11. The system of claim 10 wherein said maneuvering device is configured to move said wheel in a horizontal plane forward, backwards, left and right.

12. The system of claim 11 wherein said maneuvering device is configured to rotate said wheel 360 degrees.

13. The system of claim 8 further comprising a remote control to control said lifting jack and said maneuvering device.

14. The system of claim 1 said maneuvering device includes a first motor coupled to said wheel to turn said wheel in a horizontal plane, and a second motor coupled to said wheel to rotate said wheel.

15. An apparatus for maneuvering a trailer, the apparatus comprising:
a lifting jack configured to raise and lower a tongue of a trailer in a vertical direction;
a maneuvering device having a wheel, a first motor coupled to said wheel to turn said wheel in a horizontal plane, and a second motor coupled to said wheel to rotate said wheel;
said maneuvering device coupled to a first end of said lifting jack;
and configured to maneuver a trailer in a horizontal direction;
a bracket mounted to a second end said lifting jack opposite said first end;
a fastener to connect said bracket to the tongue of the trailer; and
a controller coupled to said lifting jack to actuate said lifting jack to raise and lower the tongue of the trailer, and coupled to said first motor and second motors to turn and rotate said wheel.

16. The apparatus of claim 15 wherein said lifting jack includes a hydraulic jack.

17. The apparatus of claim 15 wherein said lifting jack includes an electric jack.

18. The apparatus of claim 15 wherein said lifting jack includes a pneumatic jack.

19. The apparatus of claim 15 wherein said controller is configured to rotate said wheel forward, backwards, left and right.

20. The system of claim 18 wherein said controller is configured to rotate said wheel 360 degrees in a horizontal plane.
